(19) United States
(12) Patent Application Publication
(10) Pub. No.: US 2026/0039065 A1
(43) Pub. Date: Feb. 5, 2026

(54) SHIELDED CONNECTOR

(71) Applicant: SUMITOMO WIRING SYSTEMS, LTD., Mie (JP)

(72) Inventor: Takashi NISHIGUCHI, Mie (JP)

(21) Appl. No.: 19/283,557

(22) Filed: Jul. 29, 2025

(30) Foreign Application Priority Data
Aug. 2, 2024 (JP) 2024-128115

(51) Int. Cl. H01R 13/6595; H01R 13/6581

(52) U.S. Cl. CPC H01R 13/6595; H01R 13/6581

(57) ABSTRACT

A shielded connector includes an insulating housing, a conductive outer conductor held in the housing, and a conductive plate-shaped connection member connected to the outer conductor. The housing has a groove that is open to a rear surface of the housing. The connection member has a base portion disposed with a plate surface thereof aligned along the rear surface of the housing, an elastically-deformable extension portion that extends from a coupling portion that is continuous with the base portion to a contact portion that is in contact with external ground, and a locking piece that protrudes from the base portion and is arranged in the groove. The extension portion is inclined in one direction away from the rear surface of the housing toward the contact portion, and the locking piece has a plurality of locking projections that are locked to the inner surface of the groove.

### CROSS-REFERENCE TO RELATED APPLICATIONS

This application is based on and claims priority from Japanese Patent Application No. 2024-128115, filed on Aug. 2, 2024, with the Japan Patent Office, the disclosure of which is incorporated herein in its entirety by reference.

### TECHNICAL FIELD The present disclosure relates to a shielded connector.

### BACKGROUND

A connector described in JP 2024-033887 A includes an inner conductor, an outer conductor, a housing, and a plate-shaped conductive member. The outer conductor has a tubular portion that is electrically connected to a partner outer conductor. The plate-shaped conductive member extends from the inside to the outside of the housing and has a first connection portion electrically connected to a grounding member outside the housing, and a second connection portion electrically connected to the tubular portion inside the housing. JP 2016-207411 A discloses a connector in which a shell-side ground connection portion is provided on a shell that covers a housing.

### SUMMARY

Incidentally, as shown in FIG. 10 of the present disclosure, it is also possible to adopt a configuration in which a ground connection member 1 (a member corresponding to the plate-shaped conductive member of JP 2024-033887 A and the shell-side ground connection portion of JP 2016-207411 A) extends upward from a holding portion 5 held by a housing 2 and diagonally leftward from the housing 2, and the upper end portion of the ground connection member 1 is in contact with a grounding member 3 from below. The holding portion 5 has a locking portion (not shown) that is locked to the housing 2. Here, the ground connection member 1 receives a force in a rotational direction away from the housing 2 (see arrow B in FIG. 10) due to contact with the grounding member 3. At this time, the holding portion 5 serves as the center of rotation of the ground connection member 1. As a result, a large load is applied to the holding portion 5, which may cause the locking position of the locking portion to shift relative to the housing 2 or the like, and thus there is a risk that the locking force of the ground connection member 1 will weaken. If the locking force of the ground connection member 1 weakens, there is a risk that the shielding performance of a connector 4 will deteriorate.

An object of the present disclosure is to provide a shielded connector capable of ensuring a locking force when a connection member that is in contact with the ground is locked to a housing.

A shielded connector of the present disclosure includes: an insulating housing; a conductive outer conductor held in the housing; and a conductive plate-shaped connection member connected to the outer conductor, in which the housing has a groove that is open to one side surface of the housing, the connection member includes: a base portion disposed with a plate surface thereof aligned along the one side surface of the housing; an elastically-deformable extension portion extending from a coupling portion that is continuous with the base portion, to a contact portion that is in contact with external ground; and a locking piece bent from the base portion and disposed in the groove, the extension portion is inclined in one direction away from the one side surface of the housing toward the contact portion, and the locking piece has a plurality of locking projections that are locked to an inner surface of the groove.

According to the present disclosure, it is possible to provide a shielded connector capable of ensuring a locking force when a connection member that is in contact with the ground is locked to a housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a shielded connector according to a first embodiment, as viewed from behind.

FIG. 2 is a side cross-sectional view of the shielded connector according to the first embodiment, showing a state in which the shielded connector is installed on a circuit board and a connection member is connected to the ground, which is a housing.

FIG. 3 is a perspective view of the shielded connector according to the first embodiment, as viewed from below.

FIG. 4 is a perspective view of an outer conductor in the shielded connector according to the first embodiment, as viewed from the side.

FIG. 5 is a perspective view of the housing in the shielded connector according to the first embodiment, as viewed from below.

FIG. 6 is a perspective view of a connection member in the shielded connector according to the first embodiment, as viewed from below.

FIG. 7 is an enlarged rear view of the shielded connector according to the first embodiment, showing a state in which a locking piece has been inserted into a groove.

FIG. 8 is an enlarged perspective view of a locking piece in the shielded connector according to the first embodiment, as viewed from the side.

FIG. 9 is an enlarged cross-sectional view of the shielded connector according to the first embodiment, showing a state in which a locking piece has been inserted into a groove and a plurality of locking projections are locked to an inner surface of the groove.

FIG. 10 is a schematic diagram of a connector shown for reference, illustrating a state in which a ground connection member and a ground member are in contact with each other.

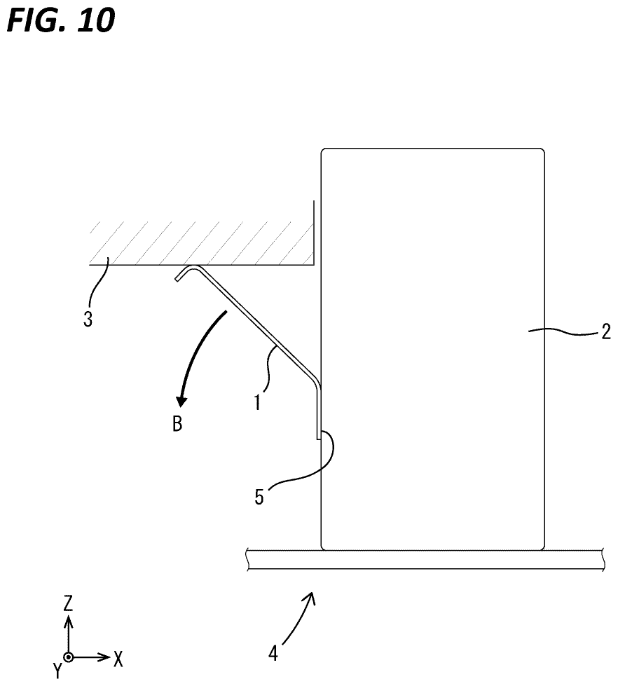

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.

(1) A shielded connector of the present disclosure is a shielded connector including: an insulating housing; a conductive outer conductor held in the housing; and a conductive plate-shaped connection member connected to the outer conductor, in which the housing has a groove that is open to one side surface of the housing, the connection member includes: a base portion disposed with a plate surface thereof aligned along the one side surface of the housing; an elastically-deformable extension portion extending from a coupling portion that is continuous with the base portion, to a contact portion that is in contact with external ground; and a locking piece bent from the base portion and disposed in the groove, the extension portion is inclined in one direction away from the one side surface of the housing toward the contact portion, and the locking piece has a plurality of locking projections that are locked to an inner surface of the groove.

According to (1) above, even if a force is applied to the connection member in a rotational direction away from the one side surface of the housing due to contact between the connection member and the external ground, the locking force of the plurality of locking projections can resist the force. Accordingly, the connection member can be prevented from rotating.

(2) In the shielded connector according to (1) above, it is preferable that one of the plurality of locking projections protrudes in one direction in the plate thickness direction of the locking piece, and the other of the plurality of locking projections protrudes in the other direction in the plate thickness direction of the locking piece.

According to (2) above, when the locking piece is inserted into the groove, one of the locking projections is locked to one surface of the inner surface of the groove, and the other of the locking projections is locked to the other surface of the inner surface of the groove. This makes it possible to prevent the sliding tracks (movement tracks) of the one locking projection and the other locking projection from overlapping on the inner surface of the groove, and allows each locking projection to be stably held on the inner surface of the groove.

(3) In the shielded connector according to (2) above, it is preferable that the plurality of locking projections are arranged side by side on a plate surface of the locking piece at positions on a straight line extending in a bending direction of the locking piece.

According to (3) above, the plate width of the locking piece (the width of the plate surface of the locking piece in the direction perpendicular to the bending direction of the locking piece) can be reduced, which makes it possible to accommodate size reduction of the shielded connector.

(4) In the shielded connector according to (1) above, it is preferable that a plate width direction of the base portion is oriented in a width direction of the one side surface of the housing, the groove is provided at both end portions in a width direction of the one side surface of the housing, a pair of the locking pieces are bent from both end portions in the plate width direction of the base portion, and the base portion gradually widens from the coupling portion toward the locking pieces.

According to (4) above, when the connection member comes into contact with the external ground, the stress generated in the base portion can be dispersed to the wide portion extending from the coupling portion toward the locking piece. Accordingly, the connection member is less likely to rotate in a direction away from the one side surface of the housing.

(5) In the shielded connector according to (1) above, it is preferable that the extension portion has a base including the coupling portion, a distal end including the contact portion, and an intermediate portion disposed between the base and the distal end, the plate width of the base is larger than the plate width of the distal end, and the intermediate portion gradually narrows from the base toward the distal end.

According to (5) above, since the plate width of the base is larger than that of the distal end, the strength of the base can be improved compared to a case where the plate widths of the base and the distal end are the same. Also, since the plate width of the distal end is smaller than that of the base, the elastic force of the connection member can be reduced compared to a case where the plate widths of the base and the distal end are the same. Also, the intermediate portion is gradually narrowed from the base to the distal end, and therefore the stress generated in the intermediate portion can be dispersed.

(6) In the shielded connector according to any one of (1) to (5) above, it is preferable that the extension portion extends linearly from the coupling portion to the contact portion.

According to (6) above, the processing steps of the connection member can be easily simplified. Accordingly, the cost of the shielded connector can be reduced.

### Details of Embodiments of the Present Disclosure

Specific examples of the embodiments of the present disclosure will be described below with reference to the drawings. Note that the present invention is not limited to this example, but is defined by the claims, and all modifications within the meaning and scope equivalent to the claims are intended to be encompassed therein.

### FIRST EMBODIMENT

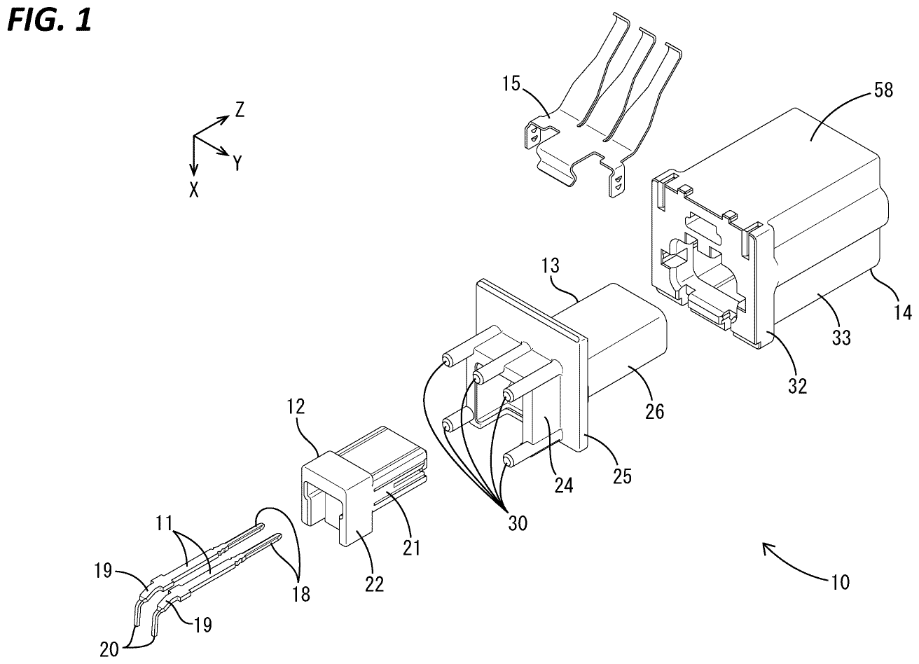

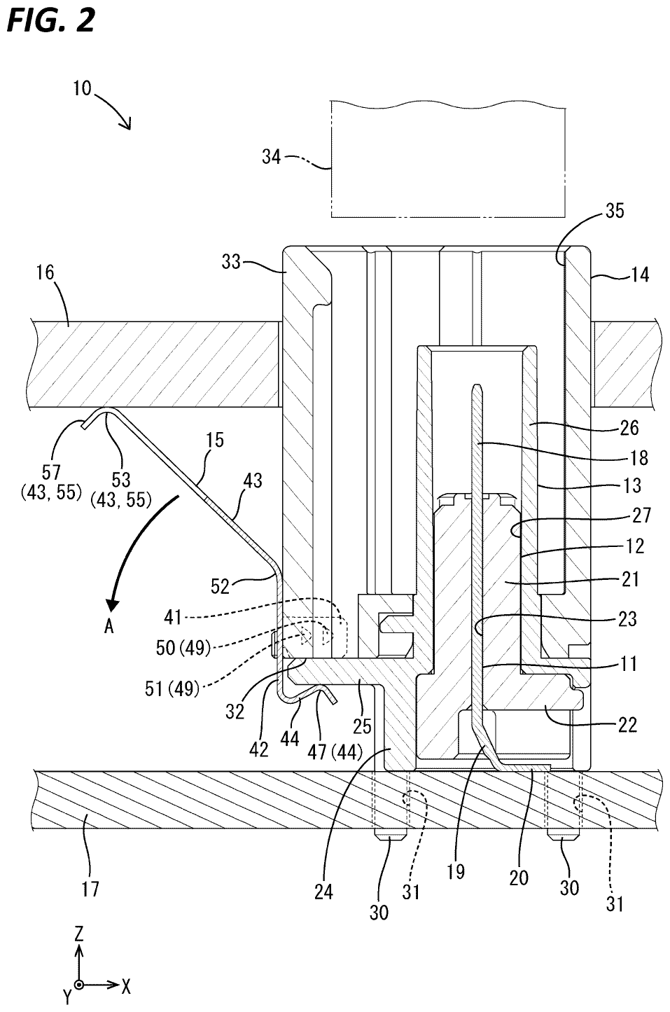

A specific example of a first embodiment of the present disclosure will be described with reference to FIGS. 1 to 9. As shown in FIG. 1, a shielded connector 10 includes inner conductors 11, a dielectric 12, an outer conductor 13, a housing 14, and a connection member 15. As shown in FIG. 2, the connection member 15 is electrically connected to external ground 16. The ground 16 is a metal housing. The shielded connector 10 is a substrate connector that is mounted on a circuit board 17. Note that in each drawing, the X direction, the Y direction, and the Z direction represent frontward, rightward, and upward, respectively. In the case of the first embodiment, upward is the side where a partner connector 34 is fitted to the shielded connector 10. The left-right direction coincides with the width direction of the housing 14. Note that these directional references do not necessarily coincide with directional references when the shielded connector 10 is mounted in a vehicle or the like (not shown).

### Inner Conductor 11

As shown in FIG. 1, the inner conductors 11 are conductive metal plate materials and have a tab or pin shape. In the case of the first embodiment, the shielded connector 10 includes two inner conductors 11 that have the same shape. Each inner conductor 11 has a partner connection portion 18, a relay portion 19, and a board connection portion 20. The partner connection portion 18 extends in the up-down direction. As shown in FIG. 2, the lower portion of the partner connection portion 18 is held by the dielectric 12. The upper portion of the partner connection portion 18 protrudes above the dielectric 12. The relay portion 19 is disposed between the partner connection portion 18 and the board connection portion 20. The relay portion 19 extends from the lower end of the partner connection portion 18 while inclining downward and frontward. The board connection portion 20 extends frontward from the lower end of the relay portion 19. The board connection portion 20 is disposed along the upper surface of the circuit board 17 and is connected to a conductive portion of the circuit board 17 through soldering.

### Dielectric 12

The dielectric 12 is made of a synthetic resin. As shown in FIG. 2, the dielectric 12 has an L-shaped block shape in a view from the side. The dielectric 12 has a terminal mounting portion 21 and a terminal lead-out portion 22. The terminal mounting portion 21 has a shape extending in the up-down direction. The terminal lead-out portion 22 is connected to the lower end of the terminal mounting portion 21 and extends frontward.

The terminal mounting portion 21 has a plurality of mounting holes 23. Each mounting hole 23 is formed in the up-down direction. In the case of the first embodiment, two mounting holes 23 are provided at an interval in the left-right direction. The partner connection portions 18 of the inner conductors 11 are inserted into the mounting holes 23 from below. The lower portions of the partner connection portions 18 are press-fitted into the mounting holes 23 and held therein.

### Outer Conductor 13

The outer conductor 13 is conductive and is formed by die casting. As shown in FIG. 2, the dielectric 12 having the inner conductor 11 mounted thereon is disposed inside the outer conductor 13. The outer conductor 13 has, in order from bottom to top, a bottom portion 24, a flange portion 25, and a tubular portion 26.

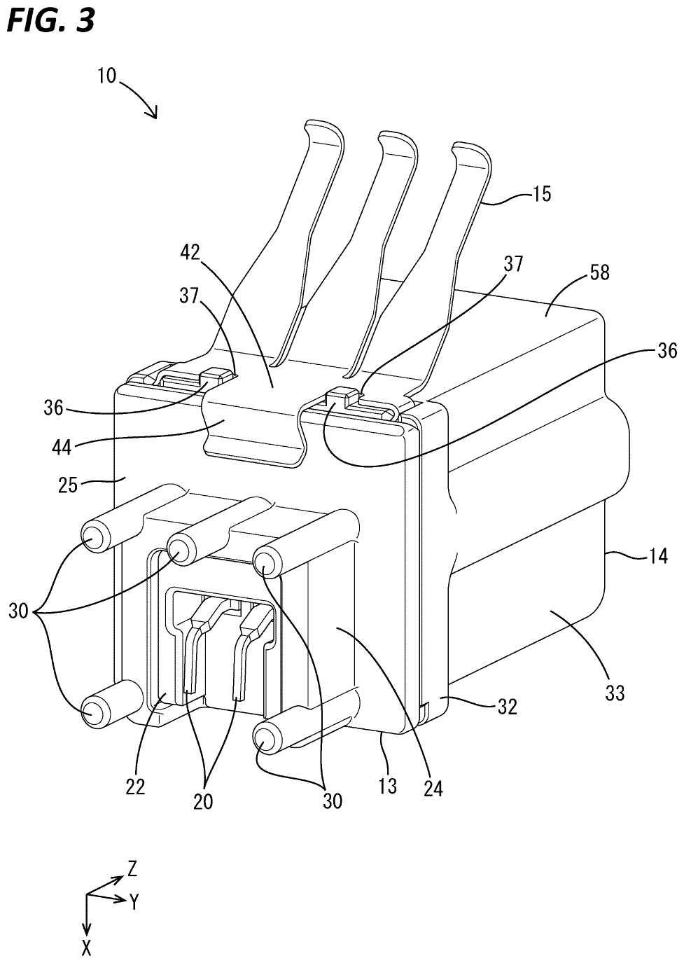

As shown in FIG. 3, the flange portion 25 is in the form of a flat plate, and has a rectangular outer shape in a view from the bottom. The bottom portion 24 protrudes downward from the flange portion 25. The bottom portion 24 has a gate-like shape in a view from the bottom, and is open frontward and downward.

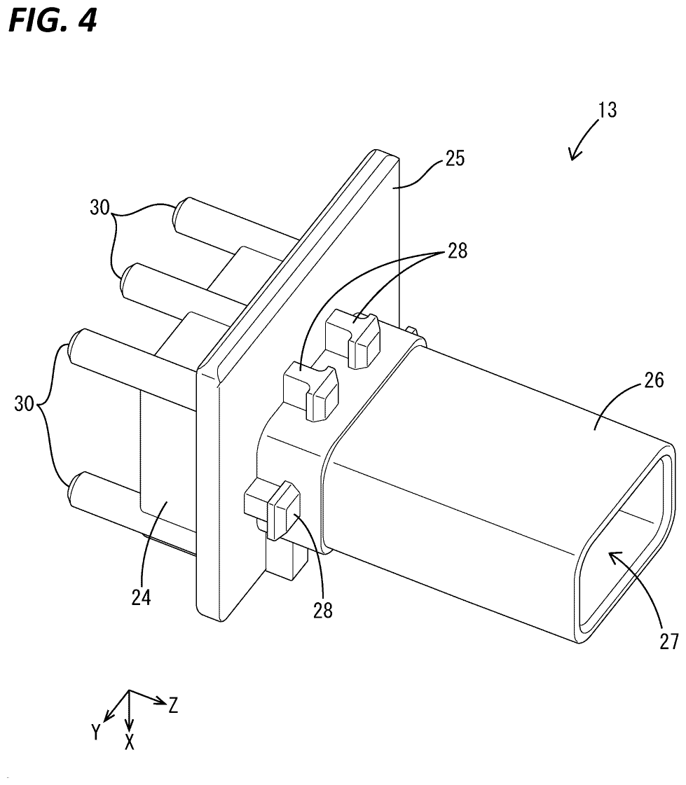

As shown in FIG. 4, the tubular portion 26 protrudes upward from the flange portion 25. The tubular portion 26 has a rectangular tube shape with rounded corners and is open upward. As shown in FIG. 2, the outer conductor 13 has an insertion hole 27 that passes through from the flange portion 25 to the tubular portion 26 in the up-down direction.

The terminal mounting portion 21 of the dielectric 12 is inserted into the insertion hole 27 from below the outer conductor 13, through the inside of the bottom portion 24. The upper end surface of the terminal mounting portion 21 is disposed at an intermediate portion in the up-down direction of the insertion hole 27 of the tubular portion 26. An upper end portion of the partner connection portion 18 of the inner conductor 11 protrudes from the upper end surface of the terminal mounting portion 21 and is disposed in the insertion hole 27 of the tubular portion 26. The relay portion 19 of the inner conductor 11 protrudes downward from the insertion hole 27 of the flange portion 25 and is disposed inside the bottom portion 24 except for its lower end portion. The board connection portion 20 of the inner conductor 11 is disposed frontward from the inside of the bottom portion 24 and is connected to the circuit board 17. The terminal lead-out portion 22 of the dielectric 12 is accommodated inside the bottom portion 24.

As shown in FIG. 4, the upper surface of flange portion 25 is formed with a plurality of protrusions 28 protruding therefrom. The protrusions 28 are arranged on the outer peripheral surface of the tubular portion 26 at intervals in the peripheral direction. Each of the protrusions 28 is coupled to the outer peripheral surface of the tubular portion 26 while extending in the up-down direction. The protrusions 28 can be locked in recesses 29 of the housing 14, which will be described later.

A plurality of board attachment portions 30 are formed protruding from the lower surface of the flange portion 25. As shown in FIG. 3, each board attachment portion 30 has a cylindrical shape, and here, five board attachment portions are formed in total. Of the board attachment portions 30, four board attachment portions 30 are respectively coupled to the four corners of the bottom portion 24 up to a position partway downward from the lower surface of the flange portion 25, and the remaining board attachment portion 30 is coupled to an intermediate portion in the left-right direction of the rear surface up to the above-mentioned partway position. As shown in FIG. 2, the lower end portions (the portions below the bottom portion 24) of the board attachment portions 30 are positioned and inserted into a plurality of attachment holes 31 provided in the circuit board 17.

### Housing 14

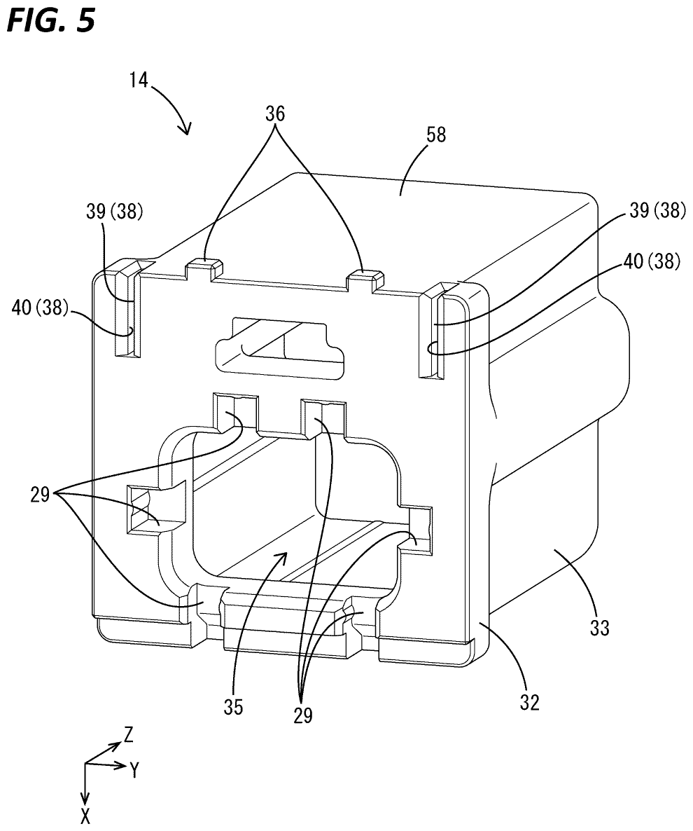

The housing 14 is made of synthetic resin. As shown in FIG. 5, the housing 14 has a rectangular tube shape. The housing 14 has a bottom wall portion 32 and a fitting portion 33.

The bottom wall portion 32 has a rectangular plate shape in a view from the bottom, and forms the lower end portion of the housing 14. The fitting portion 33 protrudes upward from the outer peripheral edge of the upper surface of the bottom wall portion 32. The partner connector 34 is fitted into the fitting portion 33. As shown in FIG. 2, the housing 14 has an insertion hole 35 extending in the up-down direction from the bottom wall portion 32 to the fitting portion 33. The tubular portion 26 of the outer conductor 13 is inserted into the insertion hole 35 from below.

As shown in FIG. 5, the plurality of recesses 29 are formed in the lower surface of the bottom wall portion 32. The recesses 29 are provided to respectively correspond to the protrusions 28. Each recess 29 opens to the lower surface of the bottom wall portion 32 and opens to the inner peripheral surface of the insertion hole 35. The protrusions 28 of the outer conductor 13 are respectively inserted into and locked in the recesses 29. This allows the outer conductor 13 and the housing 14 to be coupled together in a state in which separation in the vertical direction is suppressed.

A pair of projecting portions 36 protrude from a rear surface 58 (corresponding to one side surface in this disclosure) of the housing 14. Each of the projecting portions 36 has a rectangular prism shape. The projecting portions 36 are disposed at the lower end of the rear surface 58 at intervals in the left-right direction. Each projecting portion 36 is fitted into a receiving portion 37 of the connection member 15, which will be described later.

A pair of grooves 38 are formed in the lower end of rear surface 58. Each groove 38 is disposed on the rear surface 58 outside a corresponding projecting portion 36 in the left-right direction. Each groove 38 has a slit shape. The width of each groove 38 is defined by the distance between the inner surfaces facing each other in the left-right direction. Each groove 38 extends in the front-rear direction and opens to the rear surface 58 and to the lower surface of the bottom wall portion 32. The inner surfaces of each groove 38 include a first surface 39, which is an inner wall surface in the left-right direction, and a second surface 40, which is an outer wall surface in the left-right direction. The first surface 39 and the second surface 40 face each other in the left-right direction. When the outer conductor 13 and the housing 14 are coupled, the lower surface opening of each groove 38 is closed by the flange portion 25. Locking pieces 41 of the connection member 15, which will be described later, are inserted into the grooves 38.

### Connection Member 15

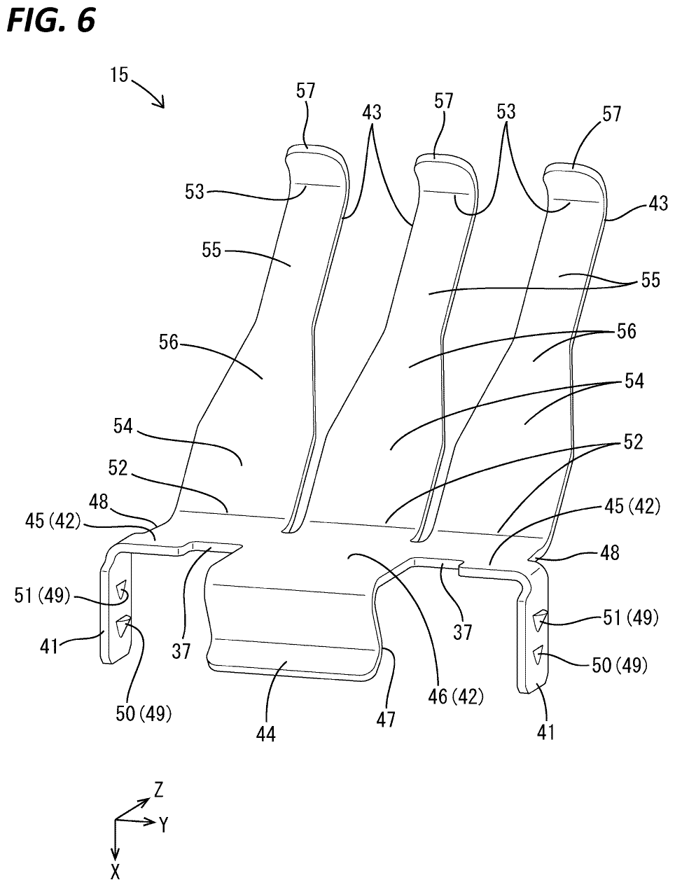

The connection member 15 is formed from a conductive metal plate. As shown in FIG. 6, the connection member 15 has a base portion 42, a plurality of elastically-deformable extension portions 43, an outer conductor connection portion 44, and the plurality of locking pieces 41.

The base portion 42 is in the form of a flat plate, with its plate width direction oriented in the left-right direction. As shown in FIG. 3, the base portion 42 is disposed along the rear surface 58 of the housing 14 so as to cover the lower end of the rear surface 58. The plate width of the base portion 42 (the dimension in the left-right direction of the base portion 42) is smaller than the width of the rear surface 58 of the housing 14 (the dimension in the left-right direction of the rear surface of the housing 14).

As shown in FIG. 6, the base portion 42 has a pair of end portions 45 disposed at both ends in the left-right direction of the base portion 42 and a central portion 46 disposed at a central portion in the left-right direction of the base portion 42. The dimension in the up-down direction of the central portion 46 is greater than the dimension in the up-down direction of the end portion 45. The end portion 45 has a pair of receiving portions 37 on the left and right sides. The receiving portions 37 are located on the inner sides in the left-right direction of the end portions 45 and are open in recessed shapes at the lower ends of the end portions 45. As shown in FIG. 3, the projecting portions 36 of the housing 14 are respectively fitted into the receiving portions 37 from below.

As shown in FIG. 6, the plate surface of the outer conductor connection portion 44 is oriented in the up-down direction. The outer conductor connection portion 44 is coupled to the lower end of the central portion 46. Specifically, as shown in FIG. 2, the outer conductor connection portion 44 has an outer conductor contact portion 47 that extends frontward while bending upward in a mountain shape in a side view. The front portion of the outer conductor connection portion 44 extends a short distance obliquely downward and frontward from the outer conductor contact portion 47. The outer conductor connection portion 44 can elastically deform in the up-down direction with the portion coupling with the central portion 46 serving as a support point. In the case of the first embodiment, the outer conductor connection portion 44 comes into contact with the lower surface of the flange portion 25 of the outer conductor 13. As a result, the outer conductor connection portion 44 is electrically connected to the outer conductor 13.

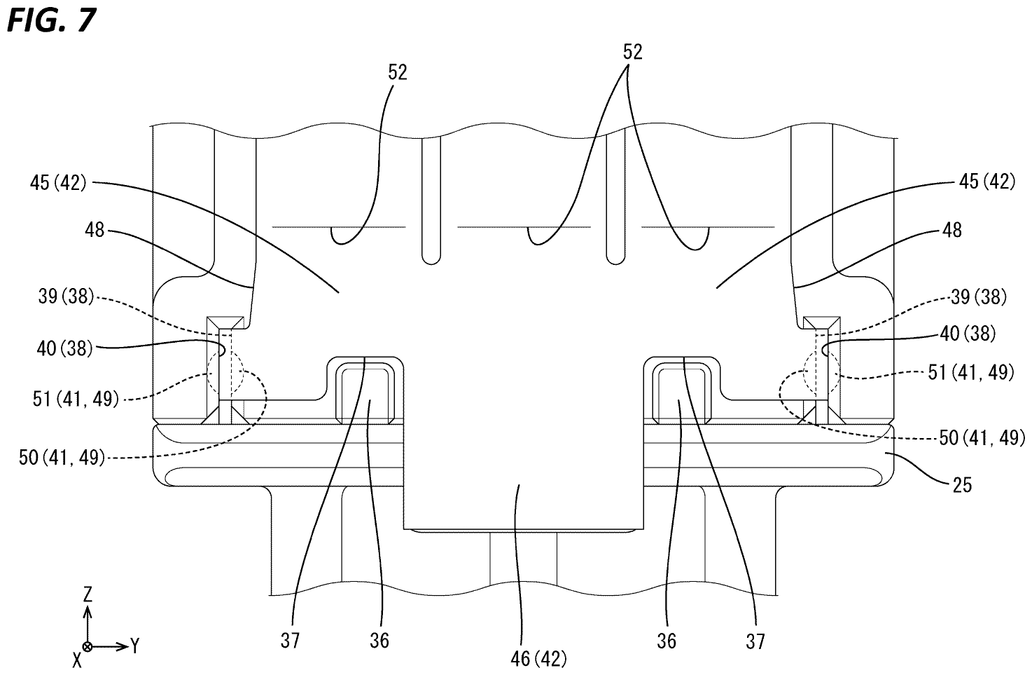

As shown in FIG. 7, the base portion 42 has a pair of inclined portions 48 that are inclined upward in a tapered manner at the edges in the left-right direction of the end portions 45. The base portion 42 is formed such that its width gradually increases from the top to the bottom in the range in the up-down direction corresponding to the inclined portions 48.

As shown in FIG. 6, the locking pieces 41 are bent (protrude) frontward from respective portions below the inclined portions 48 on the edges in the left-right direction of the end portions 45. The plate thickness direction of the locking pieces 41 is the left-right direction.

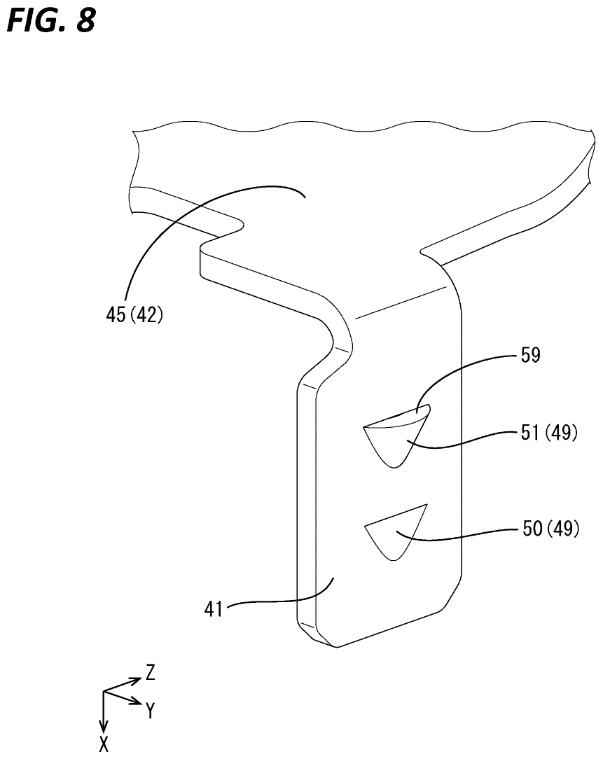

Also, the locking pieces 41 have a plurality of locking projections 49 that protrude from the plate surfaces (left and right surfaces, front and back surfaces) of the locking pieces 41 in the left-right direction, which is the plate thickness direction. The locking projections 49 are formed on the plate surfaces of the locking pieces 41 by performing bending processing such as punching or hammering, such as louver processing. As shown in FIG. 8, a rear end surface 59 of each locking projection 49 is a plate thickness surface (extruded surface or cut-out surface) of the corresponding locking piece 41, and is disposed along the up-down direction. The outer periphery of the rear end surface 59 has an arc shape that bulges out in the left-right direction in a view from behind.

The amount of protrusion in the left-right direction of each locking projection 49 gradually increases from the front end toward the rear end surface 59. Each locking projection 49 has a triangular shape in a side view, and the dimension in the up-down direction gradually increases from the front end to the rear end surface 59.

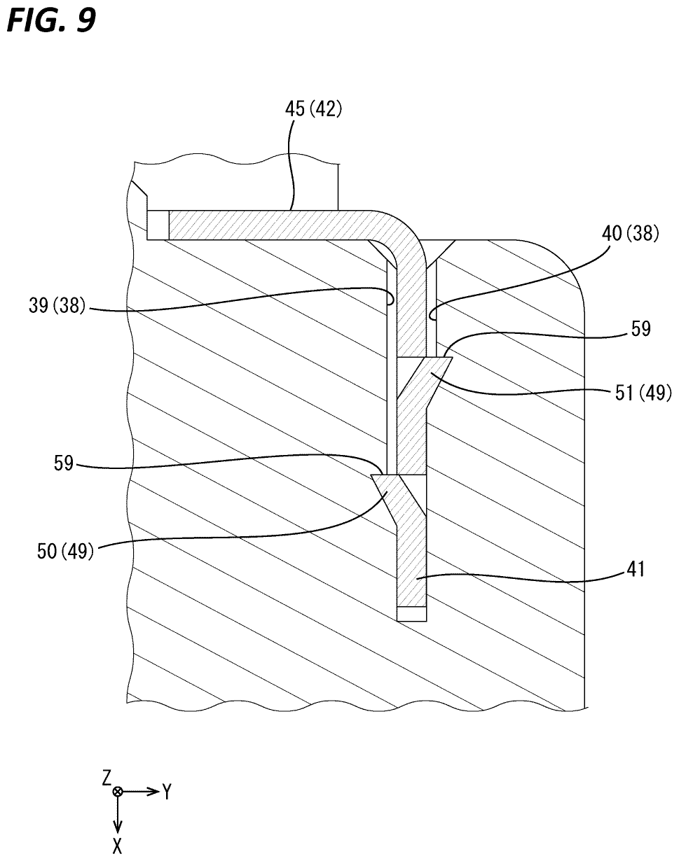

As shown in FIG. 9, each of the locking pieces 41 has a first locking projection 50 and a second locking projection 51 as the locking projections 49. The first locking projection 50 protrudes inward in the left-right direction of the locking piece 41 (toward the center in the left-right direction of the housing 14). The second locking projection 51 protrudes outward in the left-right direction from the locking piece 41 (away from the center in the left-right direction of the housing 14). As shown in FIG. 6, the first locking projections 50 are disposed at the front end portions of the locking pieces 41. The second locking projections 51 are located rearward of the first locking projections 50 and are disposed at the rear end portions of the locking pieces 41. In each of the locking pieces 41, the central portions in the up-down direction (peaks) of the first locking projection 50 and the second locking projection 51 are arranged side by side at positions on a straight line in the front-rear direction.

As shown in FIG. 7, the locking pieces 41 are inserted into the grooves 38 of the housing 14 from the rear. As shown in FIG. 9, the first locking projections 50 cut into the first surfaces 39 and are locked thereto. Similarly, the second locking projections 51 cut into the second surfaces 40 and are locked thereto.

As shown in FIG. 6, three extension portions 43 are arranged side by side in the left-right direction on the connection member 15. The plate width direction of each extension portion 43 is oriented in the left-right direction. The extension portions 43 have broken-line shapes that extend linearly in one direction (obliquely upward and rearward) gradually moving away from the rear surface 58 of the housing 14, from later-described coupling portions 52 to contact portions 53. The coupling portions 52 are connected to the upper end of the base portion 42 along the left-right direction. As shown in FIG. 2, the extension portions 43 are connected at an obtuse angle to the base portion 42 at the coupling portions 52. The extension portions 43 can be elastically deformed in the up-down direction with the coupling portions 52 serving as support points.

As shown in FIG. 6, the extension portions 43 have bases 54, distal ends 55, and intermediate portions 56. The bases 54 are portions that extend from the coupling portions 52. The plate width of each of the base 54 and the distal end 55 is constant in the extension direction of the extension portion 43. The plate width of the base 54 is larger than the plate width of the distal end 55. The distal end 55 is disposed at the end portion in the extension direction of the extension portion 43. The intermediate portion 56 is disposed between the base 54 and the distal end 55. The intermediate portion 56 is gradually narrowed from the base 54 to the distal end 55.

The contact portion 53 is the upper end portion of the distal end 55. As shown in FIG. 2, the contact portion 53 protrudes toward the ground 16 at the upper end portion of the distal end 55, and the curved upper surface is brought into contact with the lower surface of the ground 16. In the case of the first embodiment, the lower surface of the ground 16 is a horizontal surface extending along the front-rear and left-right directions.

A bent distal end 57 is coupled to the contact portion 53 of the extension portion 43. The bent distal end 57 is a rear end portion of the distal end 55, and is bent obliquely downward and rearward from the contact portion 53 to extend a short distance. Note that the connection member 15 has a symmetrical shape on both the left and right sides with respect to the center in the left-right direction of the connection member 15.

### Assembly Procedure for Shielded Connector 10

As shown in FIG. 2, the partner connection portion 18 of the inner conductor 11 is inserted into the mounting hole 23 of the dielectric 12 from below. The dielectric 12 is mounted in the outer conductor 13 after the inner conductor 11 is mounted. Specifically, the terminal mounting portion 21 of the dielectric 12 is inserted into the insertion hole 27 of the outer conductor 13 from below. Also, the tubular portion 26 of the outer conductor 13 is inserted into the insertion hole 35 of the housing 14 from below. At this time, the upper surface of the flange portion 25 of the outer conductor 13 and the lower surface of the bottom wall portion 32 of the housing 14 face each other.

After the outer conductor 13 and the housing 14 are attached, the locking pieces 41 of the connection member 15 are inserted into the grooves 38 of the housing 14 from behind, and the connection member 15 is mounted in the housing 14, as shown in FIG. 7. In the process of inserting the locking pieces 41 into the grooves 38, the locking projections 49 may scrape the inner surfaces (first surfaces 39 or second surfaces 40) of the grooves 38 and leave tracks. In the case of the first embodiment, the first locking projections 50 are locked to the first surfaces 39, and the second locking projections 51 are locked to the second surfaces 40. Accordingly, the second locking projections 51 do not follow tracks that can be formed on the first surfaces 39. For this reason, the second locking projections 51 are properly locked to the second surfaces 40.

Also, in a state in which the connection member 15 is mounted in the housing 14, the outer conductor connection portion 44 of the connection member 15 is disposed along the lower surface of the flange portion 25 of the outer conductor 13, as shown in FIG. 3. The outer conductor connection portion 44 of the connection member 15 comes into contact with the lower surface of the flange portion 25, whereby the connection member 15 is electrically connected to the outer conductor 13. This completes the assembly of the shielded connector 10.

### Action of Connection Member 15

As shown in FIG. 2, the shielded connector 10 is mounted on the circuit board 17. Also, the contact portion 53 of the extension portion 43 comes into contact with the lower surface of the ground 16 from below.

Due to a downward contact load acting on the contact portion 53, the connection member 15 receives a force in a rotational direction (see arrow A in FIG. 2) away from the housing 14, with the locking piece 41 or the vicinity of the locking piece 41 serving as a support point. As described above, the first locking projections 50 are locked to the first surfaces 39 of the corresponding grooves 38, and the second locking projections 51 are locked to the second surfaces 40 of the corresponding grooves 38 (see FIG. 9). The locking pieces 41 are respectively inserted into the grooves 38 on both the left and right sides of the housing 14, and each locking piece 41 is provided with a pair of locking projections 49, of which there are four in total. Accordingly, in the case of the first embodiment, the locking action of these many locking projections 49 can prevent the connection member 15 from rotating in the direction of arrow A (see FIG. 2), and the base portion 42 can be maintained in face-to-face contact with the rear surface 58 of the housing 14. In this way, the locking force of the connection member 15 to the housing 14 can be ensured, which results in improved shielding performance.

In addition, in the case of the first embodiment, as shown in FIG. 8, the first locking projections 50 and the second locking projections 51 are arranged side by side on a straight line extending in the front-rear direction, which is the bending direction of the locking pieces 41, on the plate surfaces of the locking pieces 41 (the left and right surfaces, front and back surfaces of the locking piece 41). The plate width of the locking pieces 41 can be made smaller than in the case where the first locking projections 50 and the second locking projections 51 are disposed offset from the above-mentioned straight line in the plate width direction of the locking pieces 41 (the up-down direction of the locking pieces 41). Accordingly, the shielded connector 10 can be made smaller.

In the case of the first embodiment, as shown in FIG. 7, the pair of inclined portions 48 are formed so as to gradually widen in the left-right direction downward toward where the locking pieces 41 are located from the coupling portions 52. According to this, when the connection member 15 comes into contact with the ground 16, the stress generated in the base portion 42 can be dispersed along the inclined portions 48. Accordingly, the connection member 15 can be further prevented from rotating in the direction of the arrow A (see FIG. 2).

In the case of the first embodiment, the plate width of the distal end 55 is smaller than the plate width of the base 54, as shown in FIG. 6. For this reason, the elastic force acting on the connection member 15 can be reduced compared to when the plate widths of the base 54 and the distal end 55 are the same. The plate width of the base 54 is larger than the plate width of the distal end 55. Accordingly, the strength of the base 54 can be improved compared to the case where the plate widths of the base 54 and the distal end 55 are the same. Since the intermediate portion 56 is gradually narrowed from the base 54 to the distal end 55, stress generated in the intermediate portion 56 can be dispersed.

In the case of the first embodiment, as shown in FIG. 6, the extension portions 43 extends linearly from the coupling portions 52 to the contact portions 53. For this reason, the processing steps for the connection member 15 can be easily simplified.

### Other Embodiments of the Present Disclosure

The above-described first embodiment disclosed herein is to be considered as illustrative in all respects and not restrictive.

In the case of the above-mentioned first embodiment, two locking projections are provided for each locking piece. In contrast to this, according to another embodiment, three or more locking projections may be provided for one locking piece.

In the case of the above-mentioned first embodiment, the locking projections are formed by louver processing. In contrast to this, according to another embodiment, the locking projections are not limited to being formed by louver processing. For example, the locking projections may be formed by cutting and raising, embossing, or the like.

In the case of the above-mentioned first embodiment, the locking projections are configured to only protrude in the plate thickness direction of the locking pieces. In contrast to this, in another embodiment, the locking projections may be configured such that some of the locking pieces protrude in the plate thickness direction and others protrude in the plate width direction.

In the case of the above-mentioned first embodiment, the first locking projections protrude inward in the left-right direction. In addition, the second locking projections protrude outward in the left-right direction. In contrast to this, according to another embodiment, the first locking projections may protrude outward in the left-right direction, and the second locking projections may protrude inward in the left-right direction. Also, both the first locking projections and second locking projections may protrude only either inward or outward in the left-right direction.

In the case of the above-mentioned first embodiment, three extension portions are arranged side by side in the left-right direction. In contrast to this, according to another embodiment, two or less or four or more extensions may be arranged side by side in the left-right direction.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A shielded connector comprising:
an insulating housing.
a conductive outer conductor held in the housing; and
a conductive plate-shaped connection member connected to the outer conductor,
wherein the housing has a groove that is open to one side surface of the housing,
the connection member includes:
a base portion disposed with a plate surface thereof aligned along the one side surface of the housing,
an elastically-deformable extension portion extending from a coupling portion that is continuous with the base portion, to a contact portion that is in contact with external ground; and
a locking piece bent from the base portion and disposed in the groove,
the extension portion is inclined in one direction away from the one side surface of the housing toward the contact portion, and
the locking piece has a plurality of locking projections that are locked to an inner surface of the groove.

2. The shielded connector according to claim 1, wherein one of the plurality of locking projections protrudes in one direction in the plate thickness direction of the locking piece, and the other of the plurality of locking projections protrudes in the other direction in the plate thickness direction of the locking piece.

3. The shielded connector according to claim 2, wherein the plurality of locking projections are arranged side by side on a plate surface of the locking piece at positions on a straight line extending in a bending direction of the locking piece.

4. The shielded connector according to claim 1,
wherein a plate width direction of the base portion is oriented in a width direction of the one side surface of the housing,
the groove is provided at both end portions in a width direction of the one side surface of the housing,
a pair of the locking pieces are bent from both end portions in the plate width direction of the base portion, and
the base portion gradually widens from the coupling portion toward the locking pieces.

5. The shielded connector according to claim 1,
wherein the extension portion has a base including the coupling portion, a distal end including the contact portion, and an intermediate portion disposed between the base and the distal end,
the plate width of the base is larger than the plate width of the distal end, and
the intermediate portion gradually narrows from the base toward the distal end.

6. The shielded connector according to claim 1, wherein the extension portion extends linearly from the coupling portion to the contact portion.
